(19) United States
(12) Patent Application Publication
(10) Pub. No.: US 2018/0065738 A1
(43) Pub. Date: Mar. 8, 2018

(54) AUTOROTATION INITIATION SYSTEM

(71) Applicant: SIKORSKY AIRCRAFT CORPORATION, Stratford, CT (US)

(72) Inventors: Nicholas D. Lappos, Guilford, CT (US); Michael Peter Strauss, New Haven, CT (US)

(21) Appl. No.: 15/563,334

(22) PCT Filed: Mar. 29, 2016
(86) PCT No.: PCT/US16/24706

§ 371 Date: Sep. 29, 2017

Related U.S. Application Data
(60) Provisional application No. 62/145,293, filed on Apr. 9, 2015.

(51) Int. Cl. B64C 27/57

(52) U.S. Cl. CPC B64C 27/57

(57) ABSTRACT

A system and method for controlling an altitude loss of an aircraft in response to a power loss event, includes obtaining at least one aircraft condition from at least one sensor, determining a present aircraft energy state of the aircraft from the at least one aircraft condition via an energy analysis unit, wherein the present aircraft energy state includes an aircraft potential energy and at least one of an aircraft kinetic energy and a rotor rotational kinetic energy, calculating a flight path to partially utilize at least one of the aircraft kinetic energy and the rotor rotational kinetic energy to initiate an autorotation state of the aircraft via a flight path controller, wherein the flight path controller minimizes an aircraft potential energy loss associated with the flight path, and initiating the autorotation state of the aircraft via the flight path.

### DESCRIPTION OF RELATED ART

The subject matter disclosed herein relates to autorotation operations in an aircraft, and to a system and a method for initiating an autorotation state in response to a power loss event.

Modern aircraft, e.g. rotary wing aircraft, unmanned aerial vehicles, etc., can utilize multiple engines for enhanced performance and system redundancy. Multi-engine aircraft can operate in single engine operation (SEO) to increase fuel efficiency, in certain scenarios, such as cruise operations.

In the event the aircraft experiences a power loss event, such as an engine failure during SEO, an autorotation state can be initiated to retain control of the aircraft while an alternative engine is engaged. Typically, an operator initiated autorotation state may result in an inefficient use of energy and a significant loss in altitude. A system and method that can initiate an autorotation state with minimal altitude loss in response to a power loss event is desired.

### BRIEF SUMMARY

According to an embodiment, a method for controlling an altitude loss of an aircraft in response to a power loss event, includes obtaining at least one aircraft condition from at least one sensor, determining a present aircraft energy state of the aircraft from the at least one aircraft condition via an energy analysis unit, wherein the present aircraft energy state includes an aircraft potential energy and at least one of an aircraft kinetic energy and a rotor rotational kinetic energy, calculating a flight path to partially utilize at least one of the aircraft kinetic energy and the rotor rotational kinetic energy to initiate an autorotation state of the aircraft via a flight path controller, wherein the flight path controller minimizes an aircraft potential energy loss associated with the flight path, and initiating the autorotation state of the aircraft via the flight path.

In addition to one or more of the features described above, or as an alternative, further embodiments could include that the power loss event is an engine failure event.

In addition to one or more of the features described above, or as an alternative, further embodiments could include identifying the power loss event.

In addition to one or more of the features described above, or as an alternative, further embodiments could include analyzing the present aircraft energy state to determine at least one of a minimum aircraft potential energy, a minimum aircraft kinetic energy, and a minimum rotor rotational kinetic energy.

In addition to one or more of the features described above, or as an alternative, further embodiments could include operating an engine of a plurality of engines of the aircraft in a single engine operation condition.

In addition to one or more of the features described above, or as an alternative, further embodiments could include providing additional power to the aircraft via an alternative engine.

In addition to one or more of the features described above, or as an alternative, further embodiments could include executing the flight path via an autopilot system controlling a plurality of aircraft parameters.

In addition to one or more of the features described above, or as an alternative, further embodiments could include that the plurality of aircraft parameters include at least one of a main rotor collective pitch parameter, a main rotor lateral cyclic pitch parameter, a main rotor longitudinal cyclic pitch parameter, and an aircraft yaw parameter from a yaw inducing device.

In addition to one or more of the features described above, or as an alternative, further embodiments could include that the flight path controller utilizes a modeled aircraft characteristic.

According to an embodiment, a system for controlling an altitude loss of an aircraft in response to a power loss event, includes at least one sensor to obtain at least one aircraft condition, an energy analysis unit to determine a present aircraft energy state of the aircraft from the at least one aircraft condition, wherein the present aircraft energy state includes an aircraft potential energy and at least one of an aircraft kinetic energy and a rotor rotational kinetic energy, a flight path controller to calculate a flight path to partially utilize at least one of the aircraft kinetic energy and the rotor rotational kinetic energy to initiate an autorotation state of the aircraft, wherein the flight path controller minimizes an aircraft potential energy loss associated with the flight path, and an auto-pilot system to initiate the autorotation state of the aircraft via the flight path.

In addition to one or more of the features described above, or as an alternative, further embodiments could include that the power loss event is an engine failure event.

In addition to one or more of the features described above, or as an alternative, further embodiments could include that the auto-pilot system identifies the power loss event.

In addition to one or more of the features described above, or as an alternative, further embodiments could include that the energy analysis unit analyzes the present aircraft energy state to determine at least one of a minimum aircraft potential energy, a minimum aircraft kinetic energy, and a minimum rotor rotational kinetic energy.

In addition to one or more of the features described above, or as an alternative, further embodiments could include that the auto-pilot system engages an alternative engine.

In addition to one or more of the features described above, or as an alternative, further embodiments could include that the auto-pilot system utilizes a plurality of aircraft parameters including at least one of a main rotor collective pitch parameter, a main rotor lateral cyclic pitch parameter, a main rotor longitudinal cyclic pitch parameter, and an aircraft yaw parameter from a yaw inducing device.

Technical function of the embodiments described above includes calculating a flight path to partially utilize at least one of the aircraft kinetic energy and the rotor rotational kinetic energy to initiate an autorotation state of the aircraft via a flight path controller, wherein the flight path controller minimizes an aircraft potential energy loss associated with the flight path, and initiating the autorotation state of the aircraft via the flight path.

Other aspects, features, and techniques will become more apparent from the following description taken in conjunction with the drawings.

### BRIEF DESCRIPTION OF THE SEVERAL VIEWS OF THE DRAWINGS

The subject matter, is particularly pointed out and distinctly claimed in the claims at the conclusion of the specification. The foregoing and other features, and advantages are apparent from the following detailed description taken in conjunction with the accompanying drawings in which like elements are numbered alike in the several FIGURES:

FIG. 1 is a schematic isometric view of an aircraft in accordance with an embodiment; and

FIG. 2 illustrates a schematic view of an exemplary autorotation initiation system in accordance with an embodiment.

### DETAILED DESCRIPTION

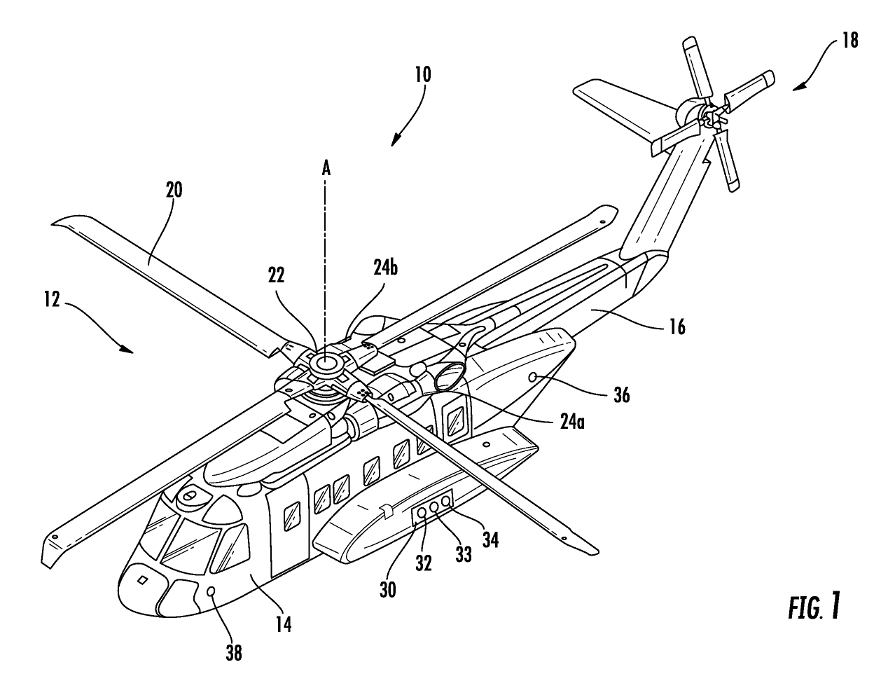

FIG. 1 schematically illustrates a rotary wing aircraft 10 which includes an autorotation initiation system according to an embodiment. The aircraft 10 includes an airframe 14 having a main rotor assembly 12 and an extending tail 16 which mounts a tail rotor system 18, such as an anti-torque system, a translational thrust system, a pusher propeller, a rotor propulsion system and the like. The main rotor assembly 12 includes a plurality of rotor blades 20 mounted to a rotor hub 22. The main rotor assembly 12 is driven about an axis of rotation A through a main rotor gearbox (not shown) by a multi-engine powerplant system, here shown as two internal combustion engines 24a-24b. The internal combustion engines 24a-24b generate the power available to the aircraft 10 for driving a transmission system that is connected to a main rotor assembly 12 and a tail rotor system 18 as well as for driving various other rotating components to thereby supply electrical power for flight operations. In embodiments, the internal combustion engines 24a-24b may include a turbine engine, a spark ignition engine, or a compression ignition engine. In embodiments, the rotary wing aircraft 10 may utilize a plurality of approaches for initiating an autorotation state if a power loss event occurs. The approaches may be utilized for a dual engine aircraft, such as the rotary wing aircraft 10 that operates in a single engine-operating (SEO) mode to save fuel and experiences a power loss event, such as an engine failure. In certain embodiments, after an autorotation state is initiated, an alternative engine 24a-24b can be engaged.

In an exemplary embodiment, rotary wing aircraft 10 includes an autorotation initiation system 30. Autorotation initiation system 30 can include an energy analysis unit 32, a flight path controller 33, and an auto-pilot system 34. Autorotation initiation system 30 can utilize at least one sensor input 36, and modify parameters and controls 38.

Although a particular helicopter configuration is illustrated and described in the disclosed embodiments, other multi-engine VTOL configurations and/or machines that transmit mechanical power from internal combustion engines to a main rotor system via a gearbox, whereby the main rotor system provides the primary lift force in hover and the primary propulsive force in forward flight, and given that such configurations exhibit a large disparity between the total vehicle power required for takeoff and hovering flight and the power required for sustained level flight at nominal cruise speeds, such as high speed compound rotary wing aircraft with supplemental translational thrust systems, dual contra-rotating, coaxial rotor system aircraft, tilt-rotors and tilt-wing aircraft, vertical takeoff and landing fixed wing aircraft that are oriented with their wings perpendicular to the ground plane during takeoff and landing (so called tailsitter aircraft) and conventional takeoff and landing fixed wing aircraft, will also benefit from embodiments.

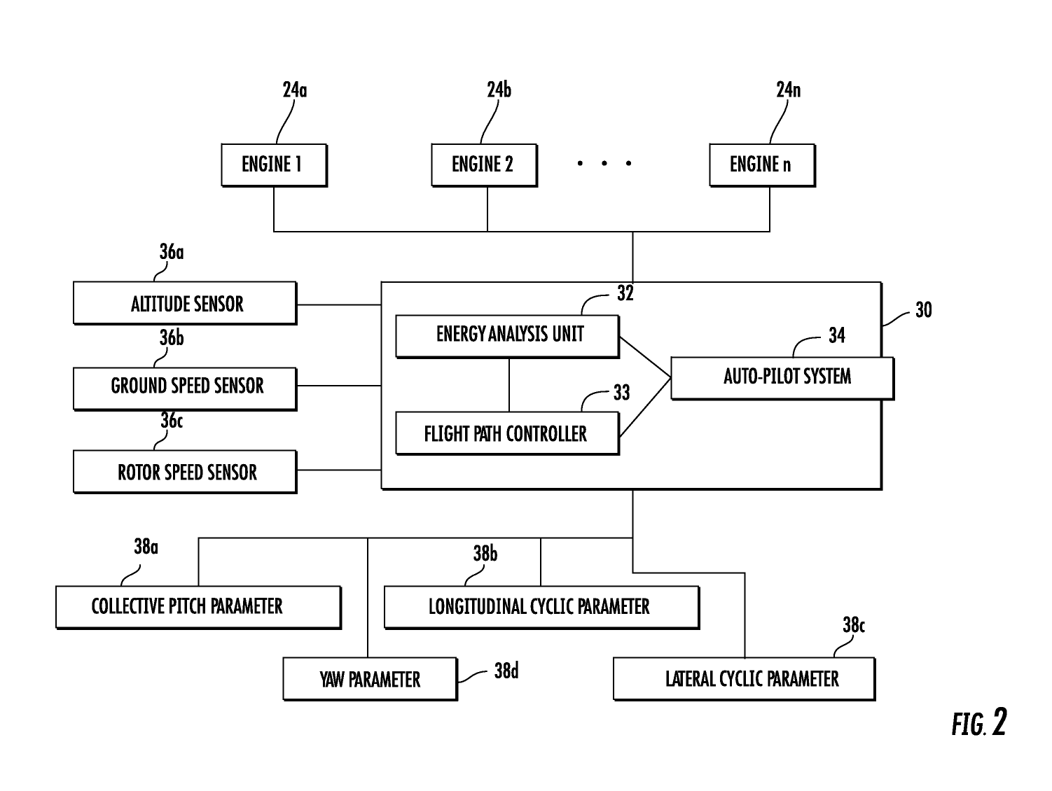

FIG. 2 illustrates an autorotation initiation system 30. In an exemplary embodiment, autorotation initiation system 30 includes an energy analysis unit 32, a flight path controller 33, and an auto-pilot system 34. In certain embodiments, autorotation initiation system 30 can receive inputs and send outputs to engines 24a-24n, sensors 36a-36c, and flight control parameters 38a-38d. In certain embodiments, portions, or all components illustrated in FIG. 2 can be combined with other shown components, or other components not shown in any combination. For example, auto-pilot system 34 may include energy analysis unit 32 and flight path controller 33, etc.

In an exemplary embodiment, aircraft 10 can have multiple engines 24a, 24b. In certain embodiments, aircraft 10 can have any suitable number of engines 24a-24n. As previously described, a multi-engine aircraft 10 can operate in a single engine operation mode, SEO, to save fuel during lower power demands. In the event of a power loss event, such as an engine failure, malfunction, environmental condition change, etc., it is desired to retain control of the aircraft 10 and engage an alternative engine.

In certain embodiments, engines 24a-24n can provide information regarding current operating status, status of engine restart systems, etc. to the autorotation initiation system 30. In an exemplary embodiment, engines 24a-24n can report a power loss event to the autorotation initiation system 30 to indicate to an operator current status or automatically engage the processes described herein.

In response to a power loss event, or any other triggering event, it is desired for a rotary wing aircraft 10 to enter an autorotation state to retain control. In an exemplary embodiment, a multi-engine aircraft 10 can then engage an alternative engine in an autorotation state. Autorotation allows airflow through main rotor assembly 12 to allow main rotor assembly 12 to continue turning even when engine power is not applied.

Typically, autorotation states are achieved by allowing aircraft 10 to descend to facilitate upward flow of air through main rotor assembly 12. In certain embodiments, parameters such as collective pitch, rotor rpm, forward airspeed, cyclic pitch control, and altitude must be monitored and adjusted.

Advantageously, autorotation initiation system 30 utilizes parameters such as forward velocity, rotor speed, etc., in addition to potential energy (altitude) which are analyzed as an aircraft energy state to initiate an autorotation state, which allows less loss of altitude compared to traditional methods during autorotation.

In an exemplary embodiment, sensors 36a, 36b, 36c can be utilized to provide information to autorotation initiation system 30. In an exemplary embodiment, sensors can include, but are not limited to an altitude sensor 36a, a ground speed sensor 36b, and a rotor speed sensor 36c. An aircraft 10 can include any suitable sensors for air density, air temperature, humidity, attitude, pitch, yaw, rotation, etc. In certain embodiments, sensors can provide a reliable measure of the state of an automatic restart system found on engines 24a-24n. In an exemplary embodiment, output from sensors 36a-36c can be utilized to determine an associated energy state of the aircraft 10 for autorotation initiation calculations.

In an exemplary embodiment, a loss of power event, triggering event, etc., is indicated to autorotation initiation system 30. In certain embodiments, autorotation initiation system 30 can be engaged by an operator.

In an exemplary embodiment, energy analysis unit 32 can receive information from sensors 36a-36c and engines 24a-24n to determine a present energy state. Advantageously, by calculating a current energy state, evaluations can be made regarding how to best initiate the autorotation state by conserving certain energies and expending others while maintaining operational parameters within certain bounds.

In an exemplary embodiment, energy analysis unit 32 obtains a present aircraft energy state by performing a plurality of energy calculations. In certain embodiments, the present aircraft energy state can be calculated by determining a plurality of energy states, including, but not limited to, a present aircraft kinetic energy, a rotor/rotational kinetic energy, and an aircraft potential energy, etc.

In an exemplary embodiment, an aircraft kinetic energy can be calculated from an airspeed sensor, a ground speed sensor 36b, etc. The aircraft kinetic energy can be calculated by utilizing:

$$\frac{1}{2} {mv}^{2} = Aircraft Kinetic Energy$$

wherein m is aircraft mass and v is an aircraft velocity. In certain embodiments, energy analysis unit 32 can calculate a minimum allowable aircraft kinetic energy.

In an exemplary embodiment, a rotor/rotational kinetic energy can be calculated from a rotor speed sensor 36c, etc. The rotor kinetic energy can be calculated by utilizing:

$$\frac{1}{2} {I}_{r} {R}^{2} = Rotor Kinetic Energy$$

wherein Iᵣ is the polar moment of the rotating element and R² is the angular velocity of the rotating element, such as main rotor assembly 12. In certain embodiments, energy analysis unit 32 can calculate a minimum allowable rotor kinetic energy.

In an exemplary embodiment, an aircraft potential energy is the energy of the aircraft due to altitude. Sensor readings from an altimeter 36a or other measurements can be used. The aircraft potential energy can be calculated by utilizing:

mgh=Aircraft Potential Energy

wherein m is the mass of the aircraft, g is gravity, and h is the altitude of the aircraft from a reference point. In certain embodiments, energy analysis unit 32 can calculate a minimum allowable aircraft potential energy.

In certain embodiments, additional energy states can be considered in the aircraft energy state. In an exemplary embodiment, energy analysis unit 32 can relate the various energy states as a total aircraft energy state.

In an exemplary embodiment, flight path controller 33 can utilize information from energy analysis unit 32 to determine an optimized flight path to initiate autorotation while minimizing loss of altitude. In certain embodiments, sensor readings and feedback can be received from engines 24a-24n, sensors 36a-6c, auto-pilot system 34, etc.

In an exemplary embodiment, flight path controller 33 can determine a flight path to initiate autorotation by utilizing information regarding the present energy state of aircraft 10. In certain embodiments, energy demands during autorotation can be prioritized to ensure safe operation and control. In an exemplary embodiment, flight path controller 33 first prioritizes a minimum rotor rpm, secondly prioritizes a minimum safe airspeed, and thirdly prioritizes a minimum altitude loss.

Advantageously, flight path controller 33 allows available energy in the aircraft energy state to address the energy demands of an autorotation state. In an exemplary embodiment, flight path controller 33 can create a flight path (and associated flight control parameters 38a-38d) to direct energy between an aircraft potential energy, an aircraft kinetic energy, a rotor kinetic energy, etc. In an exemplary embodiment, by efficiently utilizing aircraft kinetic energy and rotor kinetic energy within safe operation limits permits a minimal loss of altitude while achieving an autorotation state. In certain embodiments, aircraft velocity can be modified to an optimal climbing speed from the previous cruise speed.

In certain embodiments, flight path control 33 can utilize aircraft models and knowledge in determining an optimal flight path to initiate autorotation. Aircraft characteristics can include, but are not limited to an aircraft drag curve, a rotor inclination, etc.

In an exemplary embodiment, flight path controller 33 can communicate with auto-pilot system 34 to provide the calculated flight path to initiate autorotation. In certain embodiments, flight path controller 33 logic is integrated with auto-pilot system 34.

In an exemplary embodiment, auto-pilot system 34 utilizes available controllable parameters, such as main rotor collective pitch control 38a, main rotor longitudinal cyclic pitch control 38b, main rotor lateral cyclic pitch control 38c, aircraft yaw control 38d from a tail rotor or other yaw inducing device, etc. to execute the flight path to initiate an autorotation state. The parameters adjusted can be any suitable parameters. Advantageously, aircraft 10 can experience a loss of power event and enter an autorotation state without any negative effects.

In an exemplary embodiment, after aircraft 10 has entered an autorotation state, an alternative engine can be engaged, i.e. transition from SEO1 to SEO2 can be performed. In certain embodiments, an alternative engine can be engaged after a power loss event is determined, and before or during initiating an autorotation state. In certain embodiments, engaging an alternative engine can be performed automatically or performed by an operator.

The terminology used herein is for the purpose of describing particular embodiments only and is not intended to be limiting. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while the various embodiments have been described, it is to be understood that aspects may include only some of the described embodiments. Accordingly, the embodiments are not to be seen as limited by the foregoing description, but are only limited by the scope of the appended claims.

1. A method for controlling an altitude loss of an aircraft in response to a power loss event, the method comprising:
obtaining at least one aircraft condition from at least one sensor;
determining a present aircraft energy state of the aircraft from the at least one aircraft condition via an energy analysis unit, wherein the present aircraft energy state includes an aircraft potential energy and at least one of an aircraft kinetic energy and a rotor rotational kinetic energy;
calculating a flight path to partially utilize at least one of the aircraft kinetic energy and the rotor rotational kinetic energy to initiate an autorotation state of the aircraft via a flight path controller, wherein the flight path controller minimizes an aircraft potential energy loss associated with the flight path; and
initiating the autorotation state of the aircraft via the flight path.

2. The method of claim 1, wherein the power loss event is an engine failure event.

3. The method of claim 1, further comprising identifying the power loss event.

4. The method of claim 1, further comprising analyzing the present aircraft energy state to determine at least one of a minimum aircraft potential energy, a minimum aircraft kinetic energy, and a minimum rotor rotational kinetic energy.

5. The method of claim 1, further comprising operating an engine of a plurality of engines of the aircraft in a single engine operation condition.

6. The method of claim 1, further comprising providing additional power to the aircraft via an alternative engine.

7. The method of claim 1, further comprising executing the flight path via an autopilot system controlling a plurality of aircraft parameters.

8. The method of claim 7, wherein the plurality of aircraft parameters include at least one of a main rotor collective pitch parameter, a main rotor lateral cyclic pitch parameter, a main rotor longitudinal cyclic pitch parameter, and an aircraft yaw parameter from a yaw inducing device.

9. The method of claim 1, wherein the flight path controller utilizes a modeled aircraft characteristic.

10. A system for controlling an altitude loss of an aircraft in response to a power loss event, the system comprising:
at least one sensor to obtain at least one aircraft condition;
an energy analysis unit to determine a present aircraft energy state of the aircraft from the at least one aircraft condition, wherein the present aircraft energy state includes an aircraft potential energy and at least one of an aircraft kinetic energy and a rotor rotational kinetic energy;
a flight path controller to calculate a flight path to partially utilize at least one of the aircraft kinetic energy and the rotor rotational kinetic energy to initiate an autorotation state of the aircraft, wherein the flight path controller minimizes an aircraft potential energy loss associated with the flight path; and
an auto-pilot system to initiate the autorotation state of the aircraft via the flight path.

11. The system of claim 10, wherein the power loss event is an engine failure event.

12. The system of claim 10, wherein the auto-pilot system identifies the power loss event.

13. The system of claim 10, wherein the energy analysis unit analyzes the present aircraft energy state to determine at least one of a minimum aircraft potential energy, a minimum aircraft kinetic energy, and a minimum rotor rotational kinetic energy.

14. The system of claim 10, wherein the auto-pilot system engages an alternative engine.

15. The system of claim 10, wherein the auto-pilot system utilizes a plurality of aircraft parameters including at least one of a main rotor collective pitch parameter, a main rotor lateral cyclic pitch parameter, a main rotor longitudinal cyclic pitch parameter, and an aircraft yaw parameter from a yaw inducing device.
